(19) United States
(12) Patent Application Publication
(10) Pub. No.: US 2024/0111014 A1
(43) Pub. Date: Apr. 4, 2024

(54) SEARCH APPARATUS, AGGREGATION APPARATUS, SEARCH SYSTEM, SEARCH METHOD, AND NON-TRANSITORY COMPUTER READABLE MEDIUM

(71) Applicant: NEC Corporation, Minato-ku, Tokyo (JP)

(72) Inventor: Kazuki Yoshida, Tokyo (JP)

(73) Assignee: NEC Corporation, Minato-ku, Tokyo (JP)

(21) Appl. No.: 18/265,176

(22) PCT Filed: Dec. 9, 2021
(86) PCT No.: PCT/JP2021/045329

§ 371 Date: Jun. 2, 2023

(30) Foreign Application Priority Data
Dec. 11, 2020 (JP) 2020-205674

(51) Int. Cl. G01S 5/02; G01S 5/06

(52) U.S. Cl. CPC G01S 5/0268; G01S 5/0249; G01S 5/06; G01S 2205/06

(57) ABSTRACT

A search apparatus according to the present disclosure includes a transmission unit configured to transmit, at a plurality of sites, a first communication request signal to a terminal; a reception unit configured to receive, from the terminal, a first response signal to the first communication request signal; and a calculation unit configured to calculate an approximate position of the terminal, in which the reception unit receives the first response signal including a time of reception of the first communication request signal by the terminal, and the calculation unit calculates a time difference obtained from a time when the first communication request signal is transmitted and a time when the first communication request signal is received, and calculates the approximate position of the terminal using Observed Time Difference Of Arrival (OTDOA) obtained based on a time difference at at least two of a plurality of sites.

### TECHNICAL FIELD

The present disclosure relates to a search apparatus, an aggregation apparatus, a search system, a search method, and a search program.

### BACKGROUND ART

In an event of earthquakes or tsunamis, it is important to search the affected area rapidly for victims and rescue them immediately. While there are now some cases where victims of a disaster are detected and rescued using robots or the like, such victims are still normally rescued by people. In the event of a large-scale disaster, for example, in order to arrange a limited amount of rescue resources as efficiently as possible in the vast affected area, it is important to accurately collect information on positions of victims in the affected area by some method in advance.

Methods commonly used include, for example, visual confirmation from the sky, discovery by image analysis, or identification of positions of mobile terminals possessed by victims by using Global Positioning System (GPS). In the method using GPS, for example, in an open sky environment where there are no tall buildings nearby, information on positions of victims can be obtained with a positioning accuracy of several meters to a dozen or so meters. However, signals that are used in GPS positioning are too linear and tend to be reflected by buildings so that they cannot be used for positioning of terminals located indoors. Even when the terminals are located outdoors, if a large-scale disaster occurs, these signals cannot be used to identify victims who are under rubble resulting from such a disaster.

Under the above circumstances, instead of GPS, a positioning method which uses a situation of reception of radio waves of a carrier mobile base station is employed. This is a method used in a case in which a result of positioning cannot be actually acquired by positioning by GPS in a mobile terminal.

For example, Patent Literature 1 discloses a technique in a wireless communication network, in which a time of arrival of a position reference signal sequence is estimated using a radio signal that a mobile terminal has received from a base station, and then the position of the mobile terminal is estimated from, for example, the estimated time of arrival.

Further, Patent Literature 2 discloses a technique for identifying positions of mobile terminals possessed by victims using a temporary mobile base station, which is a drone, a vehicle or the like on which a simple base station is mounted.

Further, Patent Literature 3 discloses a system including a network control apparatus and at least three radio base stations, in which each of the radio base stations measures an uplink time of arrival and positions of mobile terminals are determined.

Further, Patent Literature 4 discloses a technique in which a terminal to be searched automatically responds to a position search request and then information on the position of a radio base station that has received the response and is located closest to the terminal to be searched is sent to a search requestor. According to this technique, when an area where the terminal to be searched is located is determined, a more accurate position of the terminal to be searched may be determined using a direction finder.

### CITATION LIST

### Patent Literature

[Patent Literature 1] Published Japanese Translation of PCT International Publication for Patent Application, No. 2019-531483
[Patent Literature 2] Japanese Unexamined Patent Application Publication No. 2019-27791
[Patent Literature 3] Published Japanese Translation of PCT International Publication for Patent Application, No. 2001-516194
[Patent Literature 4] Japanese Unexamined Patent Application Publication No. H06-165249

### SUMMARY OF INVENTION

### Technical Problem

As described above, techniques for acquiring information on positions of mobile terminals possessed by victims using radio waves of a base station have been known. In general, however, the distance that the radio waves of a base station for a fourth generation mobile communications system (4G) reach is several hundred meters to several kilometers. Therefore, if positions of victims are to be identified using radio waves from one base station, the positioning accuracy is extremely insufficient. Therefore, as shown in FIG. 14, a method in which an estimated range of a position of a victim is narrowed by performing three-point positioning using information on radio waves from a plurality of base stations received by a mobile terminal is employed. In FIG. 14, the terminal refers to information on radio waves received from a plurality of base stations 900a-900c and the center point of the overlap of the radio waves (star mark in FIG. 14) is calculated as a result of the positioning. The position of the terminal is within a shaded area in FIG. 14, which corresponds to a positioning error. The number of base stations may be four or larger. It is expected that the higher the density of base stations is, the higher the positioning accuracy will be. Even in this method, however, the positioning error is about 50 m to 200 m, which is not an acceptable positioning accuracy in an event of a large-scale disaster. Also, there may be cases where the above-described methods are not available because of a destruction of ground infrastructure (base stations or buildings where the base stations are installed) that may occur due to a disaster.

In order to address the aforementioned problem, in an event of a disaster, it is desirable to perform positioning using a mobile base station in which a simple base station is mounted on a drone or a vehicle as disclosed in Patent Literature 2. Such a mobile base station may move in the affected area in a flexible way. Patent Literature 2 employs, for example, a method in which a mobile base station is gradually moved and an estimated range of a position of a mobile terminal is narrowed based on a status of radio waves received from the mobile terminal.

However, even with the technique disclosed in Patent Literature 2, it is difficult to achieve a sufficiently high positioning accuracy. The present disclosure has been made in order to solve this problem and an aim of the present disclosure is to provide a search apparatus, an aggregation apparatus, a search system, a search method, and a search program capable of searching for terminals possessed by victims with a high accuracy.

### Solution to Problem

A search apparatus according to the present disclosure includes: a transmission unit configured to transmit, at a plurality of sites, a first communication request signal to a terminal; a reception unit configured to receive, from the terminal, a first response signal to the first communication request signal; and a calculation unit configured to calculate an approximate position of the terminal, in which the reception unit receives the first response signal including a time of reception of the first communication request signal by the terminal, and the calculation unit calculates a time difference obtained from a time when the first communication request signal is transmitted and the time when the first communication request signal is received, and calculates an approximate position of the terminal using Observed Time Difference Of Arrival (OTDOA) obtained based on the time difference at at least two of the plurality of sites.

An aggregation apparatus according to the present disclosure includes: a communication unit configured to receive, from a plurality of search apparatuses that transmit, at a plurality of sites, a first communication request signal to a terminal and receive, from the terminal, a first response signal to the first communication request signal, a time when the first communication request signal is transmitted and a time when the first communication request signal is received by the terminal; and a calculation unit configured to calculate a time difference obtained from the time of transmission and the time of reception and calculate an approximate position of the terminal using OTDOA obtained based on the time difference at at least two of the plurality of sites.

A search system according to the present disclosure includes: a terminal that transmits a first response signal in accordance with a first communication request signal; a plurality of search apparatuses including a transmission unit configured to transmit, at a plurality of sites, a first communication request signal to the terminal and a reception unit configured to receive, from the terminal, the first response signal including a time of reception of the first communication request signal by the terminal; and an aggregation apparatus including a communication unit configured to receive, from the plurality of search apparatuses, a time when the first communication request signal is transmitted and the time when the first communication request signal is received and a calculation unit configured to calculate a time difference obtained from the time of transmission and the time of reception and calculate an approximate position of the terminal using OTDOA obtained based on the time difference at at least two of the plurality of sites.

In a search method according to the present disclosure, a computer executes: a step of transmitting, at a plurality of sites, a first communication request signal to a terminal; a step of receiving a first response signal to the first communication request signal from the terminal; and a step of calculating an approximate position of the terminal, in which in the receiving step, the first response signal including a time of reception of the first communication request signal by the terminal is received, and in the calculating step, a time difference obtained from a time when the first communication request signal is transmitted and the time when the first communication request signal is received is calculated and the approximate position of the terminal is calculated using OTDOA obtained based on the time difference at at least two of the plurality of sites.

A search program according to the present disclosure causes a computer to execute: a step of transmitting, at a plurality of sites, a first communication request signal to a terminal; a step of receiving a first response signal to the first communication request signal from the terminal; and a step of calculating an approximate position of the terminal, in which in the receiving step, the first response signal including a time of reception of the first communication request signal by the terminal is received, and in the calculating step, a time difference obtained from a time when the first communication request signal is transmitted and the time when the first communication request signal is received is calculated and the approximate position of the terminal is calculated using OTDOA obtained based on the time difference at at least two of the plurality of sites.

### Advantageous Effects of Invention

According to the present disclosure, it is possible to provide a search apparatus, an aggregation apparatus, a search system, a search method, and a search program capable of searching for terminals possessed by victims with a high accuracy.

### BRIEF DESCRIPTION OF DRAWINGS

FIG. 1 is a block diagram showing a configuration of a search apparatus according to a first example embodiment;

FIG. 2 is a block diagram showing a configuration of a search system according to a second example embodiment;

FIG. 3 is an explanatory view of an operation in a search area searching phase of a search apparatus according to the second example embodiment;

FIG. 4 is an explanatory view of an operation in a terminal specifying phase of the search apparatus according to the second example embodiment;

FIG. 5 is an explanatory view of an operation in the terminal specifying phase of the search apparatus according to the second example embodiment;

FIG. 6 is an explanatory view of OTDOA used in the second example embodiment;

FIG. 7 is an explanatory view of AoA used in the second example embodiment;

FIG. 8 is an explanatory view of AoD used in the second example embodiment;

FIG. 9 is an explanatory view of a case in which OTDOA and AoA are used in combination with each other in the second example embodiment;

FIG. 10 is an explanatory view of a case in which OTDOA and AoA are used in combination with each other in the second example embodiment;

FIG. 11 is a sequence diagram showing processing in a search area searching phase of the search system according to the second example embodiment;

FIG. 12 is a sequence diagram showing processing in a terminal specifying phase of the search system according to the second example embodiment;

FIG. 13 is a diagram showing a hardware configuration example of a search apparatus according to the second example embodiment; and

FIG. 14 is an explanatory view of three-point positioning by a base station.

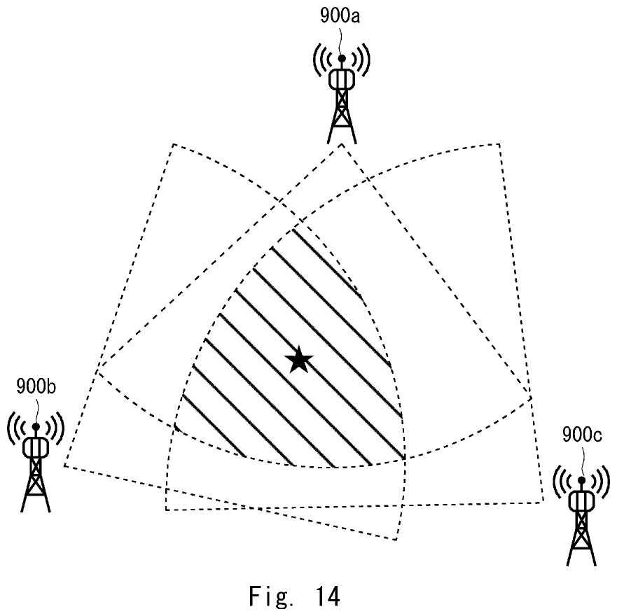

### EXAMPLE EMBODIMENT

### First Example Embodiment

Hereinafter, with reference to the drawings, example embodiments of the present disclosure will be described.

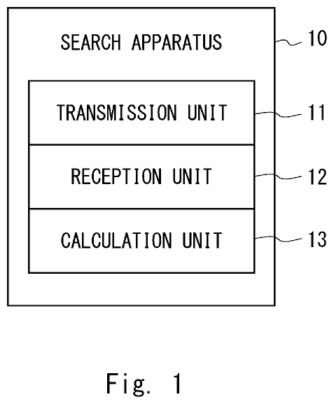

FIG. 1 is a block diagram showing a configuration of a search apparatus according to this example embodiment. The search apparatus 10 includes a transmission unit 11, a reception unit 12, and a calculation unit 13.

The transmission unit 11 transmits, at a plurality of sites, a first communication request signal to a terminal.

The reception unit 12 receives a first response signal in response to the first communication request signal from the terminal.

The calculation unit 13 calculates an approximate position of the terminal.

The reception unit 12 receives a first response signal including a time of reception of the first communication request signal in the terminal.

The calculation unit 13 calculates a time difference obtained from a time when the first communication request signal is transmitted and the time when the first communication request signal is received. In addition, the calculation unit 13 calculates an approximate position of the terminal (hereinafter it will be referred to as an approximate position) using Observed Time Difference Of Arrival (OTDOA) obtained based on a time difference at at least two of the plurality of sites to which the first communication request signal has been transmitted.

As described above, the search apparatus 10 according to this example embodiment transmits, at a plurality of sites, a communication request signal to a terminal, and receives a response signal including a time of reception of this signal in the terminal. The search apparatus 10 calculates a time difference obtained from the time when the communication request signal is transmitted and the time of reception included in the received response signal. In addition, the search apparatus 10 calculates an approximate position of the terminal using OTDOA obtained based on a time difference at at least two of the plurality of sites. Accordingly, the search apparatus 10 is able to search for terminals possessed by victims with a high accuracy.

### Second Example Embodiment

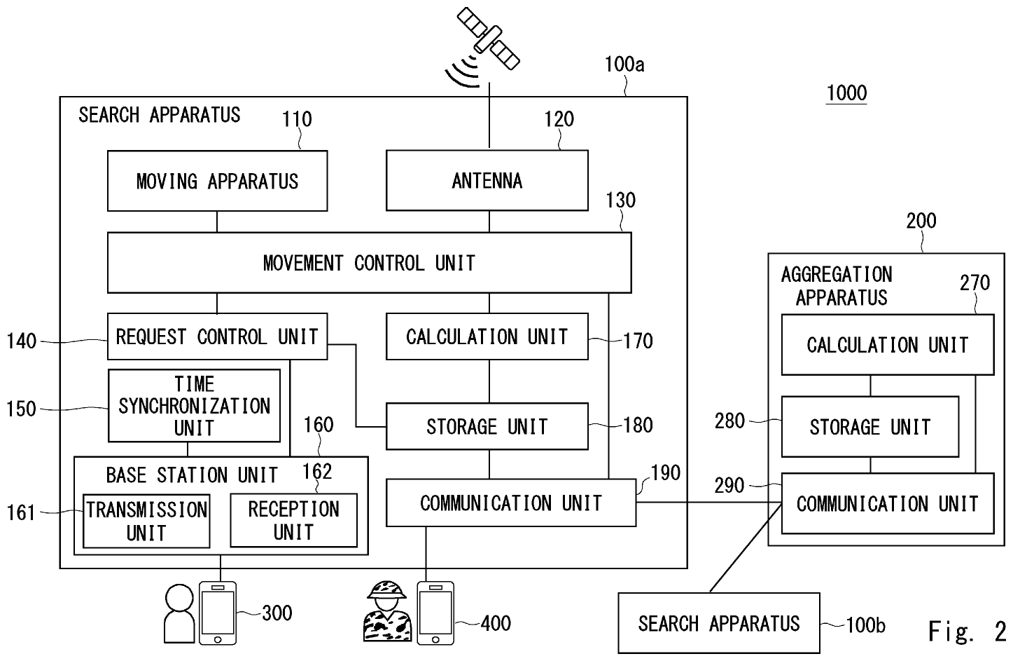

A second example embodiment is a specific example of the aforementioned first example embodiment. FIG. 2 is a block diagram showing an overall configuration of a search system 1000 according to this example embodiment.

The search system 1000 includes search apparatuses 100a and 100b, an aggregation apparatus 200, a mobile terminal 300, and a searcher's terminal 400.

The search system 1000 is a system for searching for the mobile terminal 300 possessed by a victim by the search apparatus 100 capable of moving in the air in the case of, for example, the above-mentioned disaster. The search apparatus 100 identifies the position of the mobile terminal 300 and notifies the searcher's terminal 400 possessed by the searcher of the result of the identification. While the search apparatuses 100a and 100b and the aggregation apparatus 200 that aggregates information acquired by the search apparatuses 100a and 100b are shown in FIG. 2, the search apparatus 100 alone is able to search for the mobile terminal 300. Therefore, in this example, a method in which the search apparatus 100a alone searches for the mobile terminal 300 will be mainly described.

Processing executed by the search system 1000 can be divided into two main phases. The first phase is a search area searching phase and the second phase is a terminal position specifying phase.

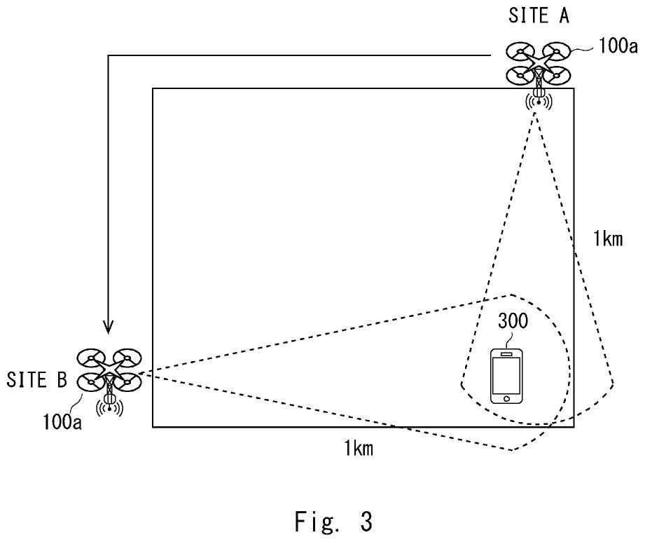

FIG. 3 is a diagram showing an operation of the search apparatus 100a in the search area searching phase. A vehicle, a drone or the like is used to use a mobile base station in the case of a disaster. In this example embodiment, it is assumed that a drone capable of moving finely and moving without being affected by obstacles on the ground is used. Therefore, the search apparatus 100a may be, for example, a drone on which an antenna capable of receiving GPS and a simple base station are mounted.

In the search area searching phase, first, the entire affected area is divided into a plurality of areas, each of which being set as a search area to be searched by the search apparatus 100a. The search area is, for example, an area indicated by a square of 1 km square as shown in FIG. 3. The search area may be set as appropriate in accordance with a range of radio waves that can be emitted from the search apparatus 100a. For example, the search area may be set in such a way that one side has a length smaller than the distance that radio waves that can be emitted from the search apparatus 100a reach.

The search apparatus 100a moves while repeatedly transmitting a communication request signal (a first communication request signal) for the mobile terminal 300 at a radio wave intensity sufficient to cover this search area. In this example, the communication request is transmitted toward the search area in a state in which angles of radio waves are narrowed. The purpose of it is to improve stability of positioning using angles of radio waves in the terminal position specifying phase.

The search apparatus 100a starts searching from, for example, a site A at a top of the search area as shown in FIG. 3. The search apparatus 100a moves as shown by the arrow in FIG. 3 while transmitting the communication request signal to the mobile terminal 300, and ends the processing in this phase at a site B.

The search apparatus 100a transmits a communication request at one site and stores, in a case in which the search apparatus 100a receives a response signal (a first response signal) from the mobile terminal 300 within a certain amount of time, radio wave information included in this response signal. The response signal received from the mobile terminal 300 includes a time of reception when the communication request signal has been received by the mobile terminal 300. In addition, this response signal may include, for example, AoD of the communication request signal from the site used for OTDOA that will be described later, or a terminal ID for identifying the mobile terminal 300.

In addition, in the following description, information such as the time of reception, AoD, the terminal ID included in the response signal from the mobile terminal 300 may be referred to as response information.

The search apparatus 100a moves to the next position when the search apparatus 100a has received a response signal or when the search apparatus 100a has not received a response signal from the mobile terminal 300 even after a certain period of time has passed.

The search apparatus 100a moves along the search area in such a manner that there is no area where a communication request signal does not reach in the search area. The search apparatus 100a may constantly move a predetermined distance or may move various distances. In a case, for example, in which it has been determined that there is only one mobile terminal 300 in the search area, the moving distance from a site at which a response signal has been received to the next site may be longer than normal. It is therefore possible to reduce the time required for searching. On the other hand, in a case in which it has been determined that there are a plurality of mobile terminals 300 in the search area or a case in which searching is performed intensively in a specific area, the moving distance from a site at which a response signal has been received to the next site may be shorter than normal. Further, the search apparatus 100a may expand or narrow down the angles of radio waves of the communication request signal depending on the circumstances of the searching.

The search apparatus 100a repeatedly performs transmission/reception of signals to/from the mobile terminal 300 and movement, and determines, at a timing when the search apparatus 100a completes movement along two sides in the search area, that this phase has ended. Then the search apparatus 100a moves to a terminal position specifying phase.

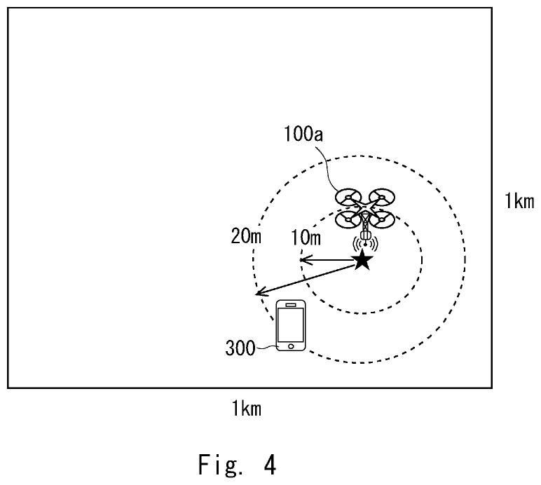

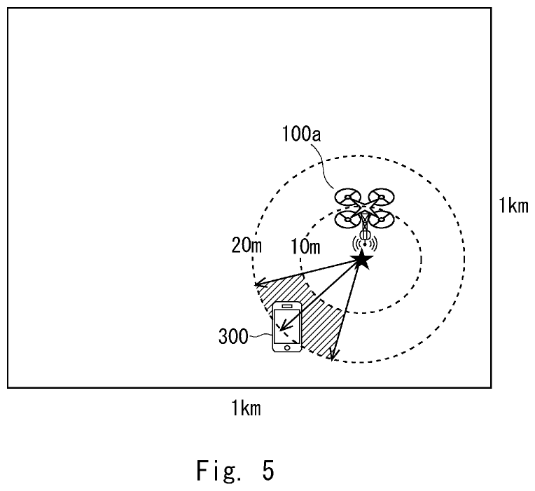

FIGS. 4 and 5 are diagrams each showing an operation of the search apparatus 100a in the terminal position specifying phase. In this phase, the search apparatus 100a first uses information included in the response signal from the mobile terminal 300 obtained in the search area searching phase and calculates an approximate position of the mobile terminal 300 by the calculation unit 170. In this example embodiment, the calculation unit 170 calculates the approximate position of the mobile terminal 300 using cell-based positioning (positioning using base station radio wave information) introduced in 5G (fifth generation mobile communications system). Accordingly, even in a case in which only one search apparatus 100 or a very small number of search apparatuses 100 can be prepared, searching may be appropriately performed in the affected area. Further, since the search apparatus 100 can perform searching in a short moving time, battery consumption of the search apparatus 100 can be reduced.

In the terminal position specifying phase, first, the calculation unit 170 calculates an approximate position of the mobile terminal 300 that has made a response based on the information stored in the search area searching phase. Specifically, the search apparatus 100a calculates the approximate position from a combination of OTDOA, Angle of Arrival (AoA), and Angle of Departure (AoD) obtained from information such as the time when radio waves are received or the angle at which radio waves are received obtained in the search area searching phase. In FIGS. 4 and 5, the calculated approximate position is shown by a star.

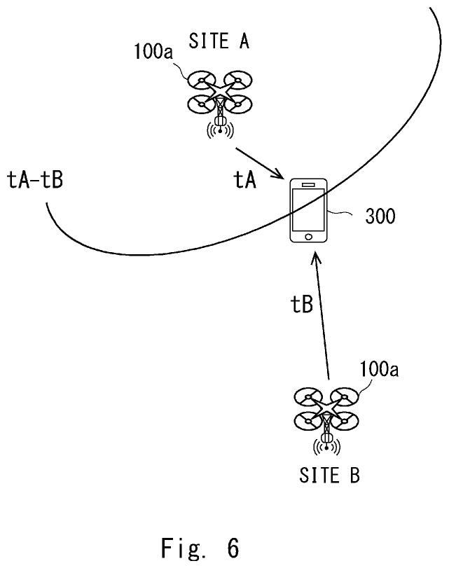

With reference to FIGS. 6 to 10, a method for calculating the approximate position by the calculation unit 170 will be described.

FIG. 6 is an explanatory view of a positioning method using OTDOA. It is assumed, for example, that there are base stations at sites A and B in FIG. 6, a communication request signal is transmitted to the mobile terminal 300 from each of the base stations at the same time, and the mobile terminal 300 has received the communication request signal. It is assumed that the times of the base stations at the sites A and B are synchronized with each other.

The mobile terminal 300 calculates signal arrival time differences tA and tB from the respective base stations using a time when the communication request signal is transmitted (at the same time) from each of the base stations and a time of reception of each communication request signal in the mobile terminal 300. Further, by connecting sites where differences between times of arrival of radio waves are equal to each other using the time difference (tA−tB) between the arrival time differences tA and tB, a curved line of OTDOA as shown in FIG. 6 may be obtained. In the positioning method of OTDOA generally used, a plurality of curved lines are created using a plurality of base stations and the intersection thereof is calculated as the position of the mobile terminal 300.

In this example embodiment, the search apparatus 100a is able to communicate with the mobile terminal 300 at the sites A and B while moving, as a result of which a curved line of OTDOA as shown in FIG. 6 can be obtained without requiring a plurality of base stations to be installed. Specifically, the search apparatus 100a acquires, at each of the sites A and B, a time when the communication request signal transmitted from the sites A and B is received by the mobile terminal 300, from the mobile terminal 300. The calculation unit 170 is able to obtain a curved line by OTDOA by calculating a time of arrival of radio waves from each site to the mobile terminal 300 using the time when radio waves are transmitted at each of the sites and the acquired time of reception.

While the curved line of OTDOA between the site A and the site B is shown in FIG. 6, in a case in which, for example, a response from the mobile terminal 300 has been obtained at three sites, two curved lines of OTDOA can be obtained. In this case, the calculation unit 170 is able to calculate a part where the two obtained curved lines overlap each other to be the approximate position of the mobile terminal 300. In a case in which a response from the mobile terminal 300 has been obtained at many more sites, a larger number of curved lines of

OTDOA can be obtained, whereby the calculation unit 170 is able to perform positioning with a higher accuracy by setting a part where these curved lines overlap each other to be the approximate position.

In addition, in a case in which a plurality of search apparatuses 100 are used, one search apparatus 100 may obtain a curved line by OTDOA from response information at a plurality of sites, as described above, or may obtain a curved line by OTDOA, like in the case in which the aforementioned base stations are used, making times of the plurality of search apparatuses 100 synchronize with one another. In the latter case, the communication request signal is transmitted to the mobile terminal 300 from the plurality of time-synchronized search apparatuses 100 at the same time. The plurality of search apparatuses 100 acquire times of reception of communication request signals from the mobile terminal 300. By aggregating information using the aggregation apparatus 200 that aggregates information on the search apparatuses 100, OTDOA can be calculated.

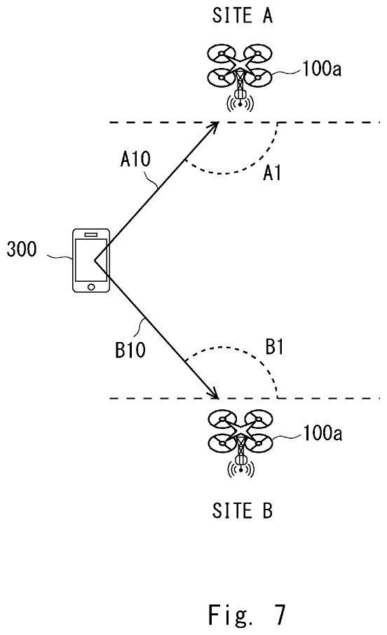

FIG. 7 is an explanatory view of a positioning method using AoA. AoA is a method for performing positioning, on the side of the base station, using angles of radio waves received from a terminal. In AoA, the incoming angle of uplink radio waves is measured by a plurality of base stations, whereby the intersection of the obtained straight lines is determined to be the result of the positioning.

In this example embodiment, the search apparatus 100a moves to a plurality of sites and receives radio waves from the mobile terminal 300 at each of the sites. Accordingly, the search apparatus 100a measures, for example, each of incoming angles A1 and B1 of the radio waves received from the mobile terminal 300 at the sites A and B. Then, the calculation unit 170 calculates the intersection of a straight line A10 obtained from the incoming angle A1 and a straight line B10 obtained from the incoming angle B1 as a result of the positioning.

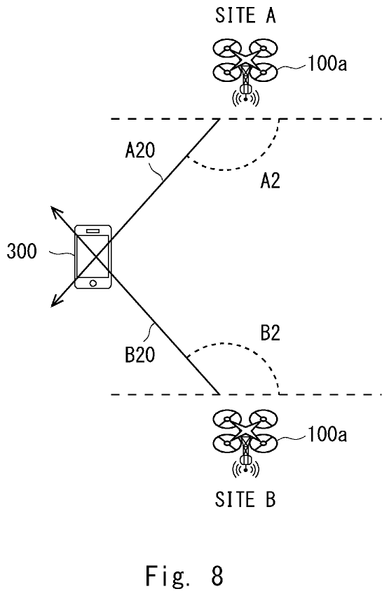

FIG. 8 is an explanatory view of a positioning method using AoD. AoD is a method for performing positioning using incoming angles of radio waves received from a base station on the terminal side. In AoD, the intersection of the straight lines obtained from the incoming angles of the radio waves received from a plurality of base stations is determined to be the result of positioning the terminal.

In this example embodiment, the search apparatus 100a moves to a plurality of sites and transmits a communication request signal to the mobile terminal 300 at each site. Accordingly, the mobile terminal 300 receives, for example, a communication request that the search apparatus 100a has transmitted from the sites A and B at the same position. The mobile terminal 300 measures incoming angles A2 and B2 of radio waves received from the search apparatus 100a, respectively. The mobile terminal 300 includes the incoming angle A2 in a response to the search apparatus 100a from the site A and includes the incoming angle B2 in a response to the search apparatus 100a from the site B and send back these response signals. Then, the calculation unit 170 calculates the intersection of the straight line A20 obtained by the incoming angle A2 with the straight line B20 obtained by the incoming angle B2 as a result of the positioning.

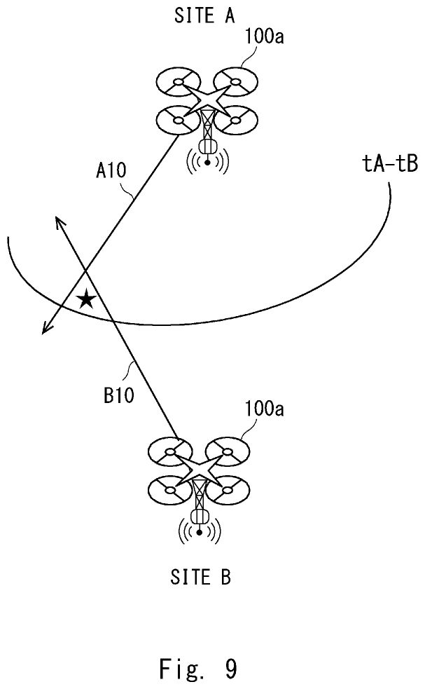

FIG. 9 is an explanatory view in a case in which OTDOA and AoA are used in combination with each other. While a combination of OTDOA with AoA is shown in FIG. 9, a case in which OTDOA and AoD are used in combination with each other may be processed in the same way.

As shown in FIG. 9, by combining the curved line of (tA−tB) obtained in OTDOA with the straight lines A10 and B10 obtained in AoA, a fan shape surrounded by these lines may be formed. The calculation unit 170 calculates the center point of this fan shape as the approximate position of the mobile terminal 300.

Likewise, by combining the curved line of (tA−tB) obtained in OTDOA with the straight lines A20 and B20 obtained in AoD, a fan shape surrounded by these lines may be formed. The calculation unit 170 calculates the center point of this fan shape as the approximate position of the mobile terminal 300.

Furthermore, the calculation unit 170 is also able to calculate a more accurate approximate position by combining them. For example, the center point of the fan shape formed by OTDOA and AoA is denoted by a and the center point of the fan shape formed by OTDOA and AoD is denoted by b. The calculation unit 170 may calculate a center point c of a straight line ab connecting the center points a and b as an approximate position of the mobile terminal 300.

Further, in a case in which there are a plurality of mobile terminals 300 in the search area, the calculation unit 170 calculates the approximate position of the mobile terminal 300 for each of terminal IDs. Further, in a case in which a response signal has been received from the mobile terminal 300 having the same terminal ID at three or more sites, the calculation unit 170 is able to calculate an approximate position with a higher accuracy using these response information items. When, for example, a response from the mobile terminal 300 has been received from three sites, the calculation unit 170 sets the center point of a triangle def connecting an intersection d of the curved line obtained by OTDOA, an intersection e of the straight line obtained by AoA, and an intersection f of the straight line obtained by AoD to be the approximate position. Accordingly, it is possible to calculate an approximate position with a higher accuracy than that in a case in which radio wave information from two sites is used.

Furthermore, the calculation unit 170 may calculate an approximate position by another method. It is assumed, for example, that the search apparatus 100a has received a response of the mobile terminal 300 from three sites, namely, sites A, B, and C. The calculation unit 170 is able to obtain a fan shape formed by OTDOA and AoA from radio wave information at two of the three sites (e.g., sites A and B). Further, since the calculation unit 170 may use AoD instead of using AoA, the calculation unit 170 may obtain a fan shape formed by OTDOA and AoD. Accordingly, the calculation unit 170 is able to obtain two fan shapes from radio wave information of the sites A and B. Here, the calculation unit 170 is able to obtain two fan shapes other than the above-mentioned fan shape by using radio wave information of two sites (e.g., sites A and C) whose combination is different from the aforementioned one. In this case, the calculation unit 170 obtains a total of four fan shapes. The calculation unit 170 may calculate the center of a rectangle connecting the centers of these four fan shapes and set this center as the approximate position of the mobile terminal 300. Accordingly, the calculation unit 170 is able to obtain an approximate position with a higher accuracy.

Note that the calculation unit 170 is able to calculate an approximate position by correcting radio wave information as necessary.

There is a case, for example, in which the intersection of the straight lines obtained by AoA or AoD is deviated from beam angles of radio waves transmitted from the search apparatus 100a. In this case, the calculation unit 170 corrects the position of this intersection in such a way that this intersection is within the range of the beam angles, and again draws a straight line of AoA or AoD. Specifically, the intersection before correction which is outside the beam is made to move onto a straight line of radio waves perpendicular to the intersection and the position after the movement is determined to be the intersection of the straight lines obtained by AoA or AoD.

Further, when a response from the mobile terminal 300 has been obtained at three or more sites, the calculation unit 170 may calculate an approximate position without using any one or all of the plurality of curved lines obtained by OTDOA as necessary.

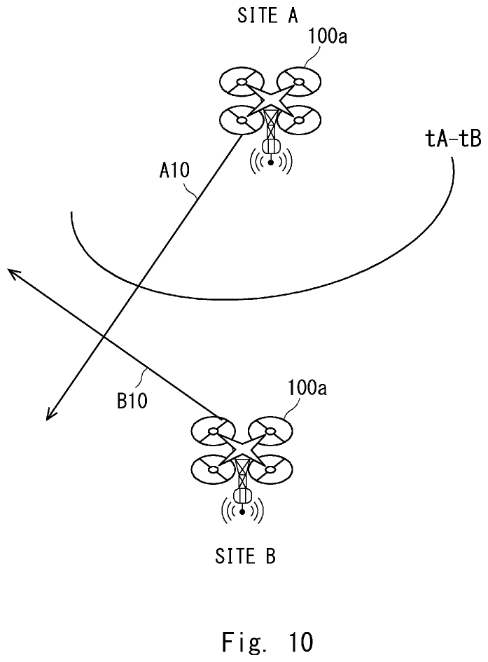

For example, as shown in FIG. 10, it is possible that a fan shape cannot be formed depending on the combination of the curved line of OTDOA obtained from radio wave information at the sites A and B and the straight lines A10 and B10 by AoA obtained at the same sites A and B. In this case, the calculation unit 170 calculates an approximate position using radio wave information obtained at two other sites (e.g., sites A and C) without using the above-mentioned curved line and straight lines. In this manner, the calculation unit 170 is able to calculate an approximate position with a high accuracy by correcting the acquired radio wave information as appropriate.

Referring once again to FIG. 4, the explanation will be continued. After the approximate position is calculated, the search apparatus 100a identifies a more specific position of the mobile terminal 300. First, as shown in FIG. 4, the search apparatus 100a moves to the calculated approximate position of the mobile terminal 300. The search apparatus 100a may move to a place near the approximate position depending on an environment such as surrounding obstacles. The search apparatus 100a transmits a communication request signal (a second communication request signal) to the mobile terminal 300 in a predetermined order in the direction of 360 degrees from the approximate position of the mobile terminal 300 using weak radio waves that can barely reach a predetermined distance from the approximate position. The predetermined distance is, for example, 10 m, 20 m, 40 m, 70 m, 100 m or the like from the approximate position and the search apparatus 100a transmits weak radio waves that can barely reach each of the above distances. Further, the predetermined order is set in advance, in such a way that, for example, the distance that radio waves arriving from the approximate position reach gradually increases from 10 m→20 m→40 m→70 m→100 m in this order. In a case in which a response signal (a second response signal) from the mobile terminal 300 is not received after a certain period of time has elapsed from the transmission of a communication request signal by weak radio waves, the search apparatus 100a again transmits a communication request signal by increasing the distance of radio waves that arrive from the approximate position in accordance with a predetermined order.

FIG. 5 is a diagram showing an operation of the search apparatus 100a when a response signal is received from the mobile terminal 300. FIG. 5 shows an operation in a case in which there is no response when a communication request signal that can reach up to 10 m from the approximate position has been transmitted and after that a response has been received after the distance that radio waves reach is increased to 20 m from the approximate position.

In a case in which the search apparatus 100a has received a response signal from the mobile terminal 300, the calculation unit 170 further calculates a more specific position of the mobile terminal 300 based on information included in the response signal and identifies the position of the mobile terminal 300. Specifically, the search apparatus 100a receives, from the mobile terminal 300, a response signal including AoD of the communication request signal transmitted from the approximate position to the mobile terminal 300. The calculation unit 170 further calculates the position of the mobile terminal 300 based on this AoD.

Further, the calculation unit 170 identifies the position of the mobile terminal 300 in view of not only the distance that radio waves of the communication request signal reach in a case in which a response signal has been received but also the distance that radio waves of the communication request signal reach in a case in which a response signal has not been received. In the example shown in FIG. 5, the calculation unit 170 calculates the position of the mobile terminal 300 using the fact that there has been a response to the communication request signal that can reach up to 20 m from the approximate position and there has been no response to the communication request signal that can reach up to 10 m from the approximate position.

The calculation unit 170 receives the aforementioned information items and further calculates the position of the mobile terminal 300 based on AoD obtained from a response signal. Here, an error range of, for example, ±10 degrees, is provided in advance for AoD obtained from the response signal. The calculation unit 170 calculates the position of the mobile terminal 300 in consideration of this error. In the example shown in FIG. 5, the shaded area corresponds to the calculated position of the mobile terminal 300. As shown in FIG. 5, by taking into consideration the information on the range where there has been no response from the mobile terminal 300, it is possible to identify the position of the mobile terminal 300 by excluding the above region.

The search apparatus 100a transmits the position of the mobile terminal 300 identified by the calculation unit 170 to the searcher's terminal 400. When a plurality of mobile terminals 300 have been detected in this phase, the search apparatus 100a moves to an approximate position of a mobile terminal 300 whose position has not yet been identified, and performs processing similar to that stated above. The search apparatus 100a repeats the aforementioned processing until positions of all the mobile terminals 300 are successfully identified. After the positions of all the mobile terminals 300 are identified, this phase is ended.

The shape of the search area, the size of the search area, the moving path of the search apparatus 100a, and the like are not limited to those described above. They may be changed as appropriate depending on the situation in the affected area, the number of search apparatuses 100, and the like.

Next, a configuration of the search apparatus 100 will be described in detail.

The search apparatus 100 includes a moving apparatus 110, an antenna 120, a movement control unit 130, a request control unit 140, a base station unit 160, a storage unit 180, a communication unit 190, a time synchronization unit 150, and a calculation unit 170. The search apparatuses 100a and 100b have a configuration similar to that of the search apparatus 100.

The moving apparatus 110 has a flying function for causing the search apparatus 100 to be able to move accurately and quickly. The moving apparatus 110 is, for example, an unmanned aerial vehicle such as a multicopter. The moving apparatus 110 is able to perform autonomous flying upon receiving an instruction from the movement control unit 130.

The search apparatus 100 is implemented by the moving apparatus 110 on which a small computer, a simple base station (base station unit 160), and a GPS antenna (antenna 120) including each functional unit are mounted. The search apparatus 100 is, for example, a flying object such as a drone.

It is assumed that a time during which the search apparatus 100 can move is about 30 minutes and a total distance that the search apparatus 100 can move is about 10 km. The moving apparatus 110 is able to move to the point as requested from the movement control unit 130 using current position information or the like obtained from a gyro sensor, a magnetic orientation sensor, or the antenna 120. The moving apparatus 110 is not limited to being a drone and may instead be, for example, a helicopter or an automobile. In addition, the performance of the moving apparatus 110 is not limited to the above-mentioned moving time and moving distance.

The antenna 120 is, for example, a GPS antenna capable of receiving a plurality of satellite radio wave information items and positioning on the order of centimeters. Accordingly, the search apparatus 100 is able to acquire a site at which the response signal has been received from the mobile terminal 300 and a time when the response signal has been received from the mobile terminal 300 with a high accuracy. The antenna 120 transmits the received radio wave information to the movement control unit 130.

The movement control unit 130 specifies the current position from the satellite radio wave information received from the antenna 120 and transmits position information and a movement request to the moving apparatus 110. The movement control unit 130 controls the moving apparatus 110 in accordance with the current position and causes the search apparatus 100 to move to the target position. After the search apparatus 100 has moved to the target position, the movement control unit 130 notifies the request control unit 140 of the current position information.

In addition, the movement control unit 130 receives a result of the positioning of the mobile terminal 300 obtained from the calculation unit 170 and also transmits a request for moving to the target position to the moving apparatus 110. After the moving apparatus 110 has moved to the target position, the movement control unit 130 notifies the request control unit 140 of the current position information. After the movement control unit 130 has received a notification indicating that processing of storing response information or the like has ended from the request control unit 140, the movement control unit 130 controls the moving apparatus 110 and causes the search apparatus 100 to move to the next target position.

The movement control unit 130 determines whether or not the search area searching phase has ended. When the processing in the search area in the search area searching phase has ended, the movement control unit 130 determines that this phase has ended. For example, the movement control unit 130 determines that this phase has ended at a timing when the search apparatus 100a ends moving along two sides of the search area while repeatedly performing transmission and reception of signals to and from mobile terminal 300.

The movement control unit 130 causes the search apparatus 100 to move to the approximate position of the terminal in accordance with a movement request from the request control unit 140.

The request control unit 140 receives a notification of the current position information from the movement control unit 130 and transmits a communication request to the base station unit 160.

In a case in which the request control unit 140 has received response information of the mobile terminal 300 from the base station unit 160, the request control unit 140 associates the current position information that the request control unit 140 holds with radio wave reception information on the side of the mobile terminal 300 and transmits the associated information to the storage unit 180. Further, in a case in which the request control unit 140 has received a notification indicating that there is no information on the mobile terminal 300 from the base station unit 160, the request control unit 140 associates this information with the current position and transmits the associated information to the storage unit 180. After the request control unit 140 has transmitted all the information items to the storage unit 180, the request control unit 140 transmits, to the movement control unit 130, a notification indicating that the processing has ended.

The request control unit 140 receives a list of approximate positions of mobile terminals 300 that exist in the search area from the calculation unit 170. The request control unit 140 specifies each of the latitude and the longitude of the approximate position, and transmits a movement request to the movement control unit 130.

The request control unit 140 transmits the result of the positioning received from the calculation unit 170 to the storage unit 180.

The request control unit 140 determines whether or not the terminal position specifying phase has ended. The request control unit 140 determines whether or not positions of all the mobile terminals 300 in the search area have been successfully identified. When the positions of all the mobile terminals 300 have successfully been identified, the request control unit 140 determines that this phase is ended.

The base station unit 160 is an example of the transmission unit 11 and the reception unit 12 according to the first example embodiment. The base station unit 160 includes a transmission unit 161 and a reception unit 162. The transmission unit 161 and the reception unit 162 correspond to the transmission unit 11 and the reception unit 12 according to the first example embodiment, respectively.

The transmission unit 161 transmits, at a plurality of sites, the first communication request signal to the mobile terminal 300 in such a way that the search area length is sufficiently covered along with the movement of the search apparatus 100 by the moving apparatus 110.

The reception unit 162 receives, from the mobile terminal 300, a first response signal to the first communication request signal. Further, the reception unit 162 receives a first response signal including a time when the first communication request signal is received by the mobile terminal 300. Further, the reception unit 162 receives, from the mobile terminal 300, a first response signal including AoD of a first communication request signal from a site used for OTDOA. Further, the reception unit 162 receives, together with these information items, a terminal ID for identifying the mobile terminal 300 by the first response signal. The terminal ID is, for example, identification information specific for each of the mobile terminals 300 stored in a non-volatile memory or the like of the mobile terminal 300.

After the approximate position has been calculated and then the search apparatus 100a has moved to the approximate position, the transmission unit 161 further transmits a second communication request signal to the mobile terminal 300 using radio waves that reach a specific distance from the approximate position. The reception unit 162 further receives a second response signal including AoD of the second communication request signal from the approximate position from the mobile terminal 300. When the second response signal is not received by the transmission unit 161, the transmission unit 161 transmits the second communication request signal again by increasing the distance of radio waves that arrive from the approximate position.

The transmission unit 161 transmits the above-described first and second communication request signals based on the communication request from the request control unit 140. The transmission unit 161 complements, to the first and second response signals received by the reception unit 162, a time when the communication request signals corresponding to these respective response signals are transmitted and AoA, and transmits these information items to the request control unit 140 as a positioning response.

The storage unit 180 receives response information from the mobile terminal 300 at a search area searching phase from the request control unit 140, associates the received response information with a terminal ID, and stores the associated information.

Further, in the terminal specifying phase, the storage unit 180 receives a result of the positioning from the request control unit 140, associates the received result of the positioning with a terminal ID, and stores the associated information. Then, the storage unit 180 transmits the result of the positioning to the searcher's terminal 400 via the communication unit 190 in the terminal specifying phase.

When searching is performed using a plurality of search apparatuses 100, a server (not shown) that manages the search apparatus 100 manages all the response information items. Accordingly, in this case, the storage unit 180 transmits the stored information to the server via the communication unit 190.

The communication unit 190 transmits the result of the positioning stored in the storage unit 180 to the searcher's terminal 400. Further, when searching is performed using a plurality of search apparatuses 100, the communication unit 190 transmits data stored in the storage unit 180 to the server after the terminal specifying phase is ended.

In a case in which a disaster area is searched using a plurality of search apparatuses 100, the time synchronization unit 150 synchronizes time among the search apparatuses 100. Accordingly, it is possible to prevent occurrence of an error when OTDOA is calculated. In a case in which a single search apparatus 100a performs searching, like in this example embodiment, there is no need to synchronize time with other search apparatuses 100.

The calculation unit 170 is one example of the calculation unit 13 described in the first example embodiment. The calculation unit 170 calculates an approximate position of the mobile terminal 300.

Further, the calculation unit 170 calculates a time difference obtained from a time when the first communication request signal is transmitted and a time when the first communication request signal is received by the mobile terminal 300. The calculation unit 170 calculates an approximate position of the mobile terminal 300 using OTDOA obtained based on the time difference at at least two of a plurality of sites.

The search apparatus 100a continues to transmit a communication request so as to cover the search area from two sides in the search area searching phase. Accordingly, the mobile terminal 300 receives a communication request transmitted from each of at least two sites and transmits a response signal in response to the communication request. Therefore, the calculation unit 170 is able to obtain a curved line (tA−tB) by OTDOA as described with reference to FIG. 6 from response information at two sites.

Further, the calculation unit 170 calculates an approximate position of the mobile terminal 300 further using AoA of the first response signal at a site used for OTDOA. Specifically, as shown in FIG. 9, a fan shape is formed by the curved line (tA−tB) obtained by OTDOA and straight lines A10 and B10 obtained by AoA. The calculation unit 170 calculates the center point of the formed fan shape as the approximate position of the mobile terminal 300.

Then, the calculation unit 170 calculates an approximate position of the mobile terminal 300 further using AoD. Specifically, in the aforementioned calculation method, the calculation unit 170 may calculate the approximate position using AoD of the first communication request signal included in the first response signal instead of using AoA of the first response signal. In this case, the calculation unit 170 calculates the center point of a fan shape formed by the curved line (tA−tB) obtained by OTDOA and straight lines A20 and B20 obtained by AoD (see FIG. 8) as the approximate position of the mobile terminal 300.

The calculation unit 170 may calculate the first approximate position using OTDOA and AoA of the first response signal at a site used for OTDOA, calculate a second approximate position using OTDOA and AoD, and calculate a third approximate position using the first and second approximate positions. Specifically, the calculation unit 170 holds the approximate position by OTDOA and AoA calculated above as the first approximate position and the approximate position by OTDOA and AoD as the second approximate position. The calculation unit 170 calculates the center point of the straight line connecting the first and second approximate positions as a third approximate position of the mobile terminal 300. Accordingly, it is possible to calculate an approximate position of the mobile terminal 300 with a high accuracy. Note that the calculation of the approximate position performed by the calculation unit 170 is not limited to the aforementioned method and the aforementioned method and another positioning method may be combined with each other.

The calculation unit 170 transmits the calculated approximate position to the request control unit 140. When there are a plurality of mobile terminals 300 in the search area, the calculation unit 170 calculates an approximate position for each of terminal IDs for identifying the mobile terminals 300. Then, the calculation unit 170 sends approximate positions of all the mobile terminals 300 to the request control unit 140.

Further, the calculation unit 170 further calculates the position of the mobile terminal 300 based on AoD of the second communication request signal in the terminal position specifying phase. Accordingly, the calculation unit 170 is able to identify a more specific position of the mobile terminal 300.

The aggregation apparatus 200 is an apparatus that aggregates, in a case in which a plurality of search apparatuses 100 are used in the search area searching phase, response information acquired by each of the search apparatuses 100 and calculates an approximate position of the mobile terminal 300. For example, in the example shown in FIG. 9, instead of performing communication at the sites A and B by a single search apparatus 100a, the search apparatus 100a communicates with the mobile terminal 300 at the site A and the search apparatus 100b communicates with the mobile terminal 300 at the site B. By aggregating the response information received by the search apparatuses 100a and 100b in the aggregation apparatus 200, the effects the same as those described above can be obtained.

As shown in FIG. 2, the aggregation apparatus 200 includes a communication unit 290, a storage unit 280, and a calculation unit 270.

The communication unit 290 receives, from a plurality of search apparatuses 100, a time when the first communication request signal is transmitted and a time when the first communication request signal is received by the mobile terminal 300. As already described above, each of the search apparatuses 100 transmits, at a plurality of sites, a first communication request signal to the mobile terminal 300 and receives a first response signal in response to the first communication request signal from the mobile terminal 300.

Further, the communication unit 290 further receives AoA of the first response signal at a site used for OTDOA.

Further, the communication unit 290 transmits response information stored in the storage unit 280 to a server.

The storage unit 280 receives response information from the mobile terminal 300 at a search area searching phase from each of the search apparatuses 100 via the communication unit 290 and stores the received response information in association with a terminal ID. The storage unit 280 transmits the stored response information to a server via the communication unit 290 at a predetermined timing.

The calculation unit 270 calculates a time difference obtained from a time when the first communication request signal is transmitted and a time when the first communication request signal is received by the mobile terminal 300. Further, the calculation unit 270 calculates the approximate position of the mobile terminal 300 using OTDOA obtained based on the time difference at at least two of the plurality of sites.

Further, the calculation unit 270 calculates an approximate position of the mobile terminal 300 further using AoA of the first response signal at a site used for OTDOA.

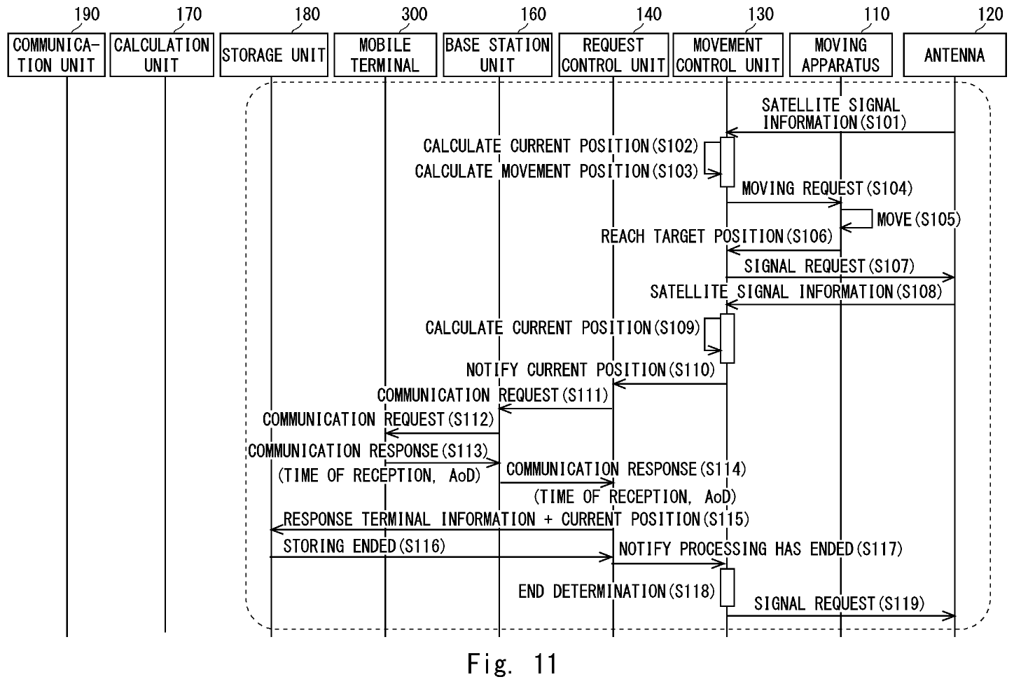

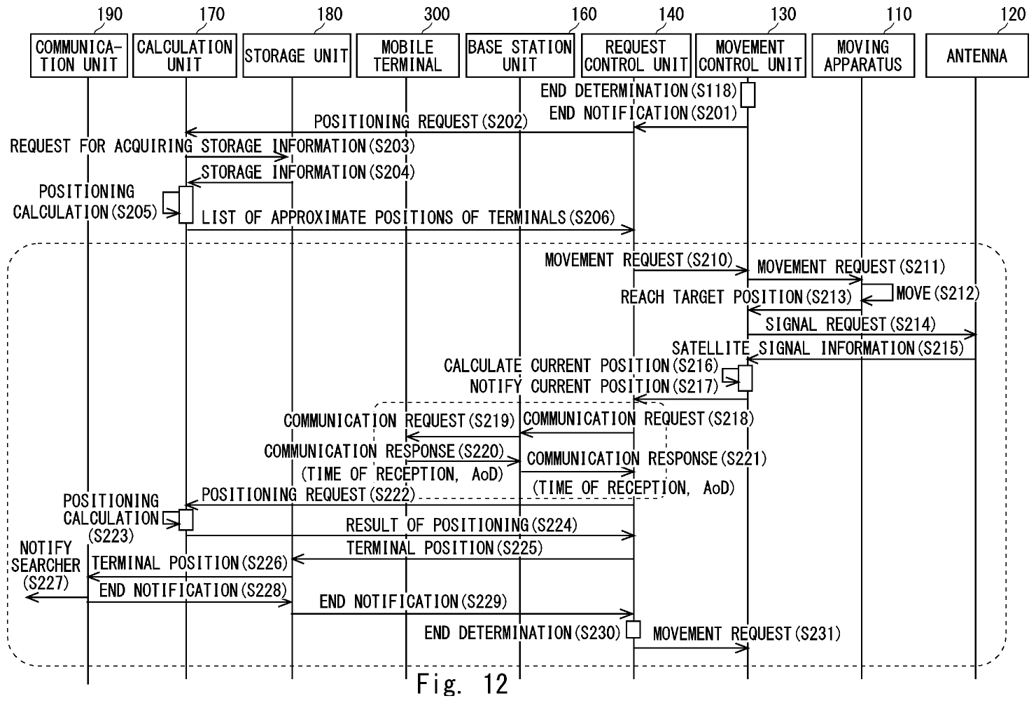

Referring next to FIGS. 11 and 12, processing in the search system 1000 will be described. FIG. 11 is a sequence diagram showing a flow of processing in the search system 1000 in the search area searching phase and FIG. 12 is a sequence diagram showing a flow of processing in the search system 1000 in the terminal position specifying phase.

First, with reference to FIG. 11, processing in the search system 1000 in the search area searching phase will be described. The antenna 120 transmits satellite signal information to the movement control unit 130 (S101). The movement control unit 130 calculates the current position (S102) and calculates the target movement position (S103). The movement control unit 130 transmits a request for moving to the target movement position to the moving apparatus 110 (S104). The moving apparatus 110 moves for the target movement position (S105). After the moving apparatus 110 arrives at the target position, the moving apparatus 110 transmits information indicating that it has arrived at the target position to the movement control unit 130 (S106). The movement control unit 130 requests the antenna 120 for satellite signal information (S107). The antenna 120 transmits the satellite signal information to the movement control unit 130 (S108).

The movement control unit 130 calculates the current position (S109) and notifies the request control unit 140 of the current position (S110). The request control unit 140 transmits a communication request to the base station unit 160 (S111). The base station unit 160 transmits the communication request to the mobile terminal 300 (S112). The mobile terminal 300 transmits a response signal including a terminal ID, a time of reception, and an AoD to the base station unit 160 (S113). The base station unit 160 transmits a response signal including these information items to the request control unit 140 (S114). The request control unit 140 transmits response terminal information and the current position to the storage unit 180 (S115). The storage unit 180 stores these information items and notifies the request control unit 140 that the storing is ended (S116).

The request control unit 140 notifies the movement control unit 130 that the processing has ended (S117). The movement control unit 130 determines whether or not the search area searching phase has ended (S118). When it is determined that the search area searching phase has not ended, the movement control unit 130 requests the antenna 120 for satellite signal information (S119). The search system 1000 repeats processing from S101 to S119 until when the search area searching phase ends. When it is determined that the search area searching phase has ended, the movement control unit 130 moves to processing in the terminal position specifying phase.

Referring next to FIG. 12, processing in the search system 1000 in the terminal position specifying phase will be described.

When it is determined in S118 that the search area searching phase has ended, the movement control unit 130 transmits an end notification to the request control unit 140 (S201). The request control unit 140 transmits a positioning request to the calculation unit 170 (S202). The calculation unit 170 transmits a request for acquiring the stored response information to the storage unit 180 (S203). The storage unit 180 transmits the stored response information to the calculation unit 170 (S204). The calculation unit 170 performs positioning calculation and calculates an approximate position of the mobile terminal 300 (S205). The calculation unit 170 transmits a list of the calculated approximate positions of the mobile terminals 300 to the request control unit 140 (S206).

The request control unit 140 transmits a movement request to the movement control unit 130 (S210). The movement control unit 130 transmits the movement request to the moving apparatus 110 (S211). The moving apparatus 110 moves for the approximate position of the mobile terminal 300, which is the target position (S212). After the moving apparatus 110 moves to the target position, the moving apparatus 110 transmits a notification indicating that the moving apparatus 110 has reached the target position to the movement control unit 130 (S213). The movement control unit 130 transmits satellite signal information to the antenna 120 (S214). The antenna 120 transmits satellite signal information to the movement control unit 130 (S215).

The movement control unit 130 calculates the current position (S216) and notifies the request control unit 140 of the current position (S217). The request control unit 140 transmits a communication request to the base station unit 160 (S218). The base station unit 160 transmits the communication request to the mobile terminal 300 (S219). The mobile terminal 300 transmits a response signal including a terminal ID, a time of reception, and an AoD to the base station unit 160 (S220). The base station unit 160 transmits a response signal including these information items to the request control unit 140 (S221). When there is no response signal from the mobile terminal 300 in response to the request transmitted in S219, the request control unit 140 and the base station unit 160 again transmit a communication request by expanding the range that the radio waves reach (S218-S221).

The request control unit 140 transmits a positioning request to the calculation unit 170 (S222). The calculation unit 170 performs positioning calculation, calculates a detailed position of the mobile terminal 300, and identifies the position of the mobile terminal 300 (S223). The calculation unit 170 transmits a result of the positioning to the request control unit 140 (S224). The request control unit 140 transmits the specified terminal position to the storage unit 180 (S225). The storage unit 180 transmits the specified terminal position to the communication unit 190 (S226). The communication unit 190 notifies the searcher's terminal 400 of the specified terminal position (S227).

The communication unit 190 notifies the storage unit 180 that a notification has been transmitted to the searcher's terminal 400 (S228). The storage unit 180 transmits the aforementioned notification to the request control unit 140 (S229). The request control unit 140 determines whether or not the terminal position specifying phase has ended (S230). When it is determined that the terminal position specifying phase has not ended, the request control unit 140 transmits a movement request to the movement control unit 130 (S231). The search system 1000 repeats processing from S210 to S231 until when the terminal position specifying phase ends. When it is determined in S230 that the terminal position specifying phase has ended, the search system 1000 ends the processing.

As described above, in the search system 1000 according to this example embodiment, in the search area searching phase, the search apparatus 100 transmits, at a plurality of sites, a communication request signal to the mobile terminal 300 while moving, and searches for the mobile terminal 300 in the search area.

Further, in the terminal position specifying phase, the search apparatus 100 calculates an approximate position of the mobile terminal 300 using response information from the mobile terminal 300. Further, the search apparatus 100 calculates the position of the mobile terminal 300 more specifically using radio waves that reach a specific distance from the calculated approximate position.

Accordingly, the search system 1000 may search for the mobile terminal 300 with a high accuracy.

The above explanation has been given in this example embodiment assuming that it is applied to the fields of rescue and emergency in an event of a large-scale disaster. The present disclosure may be used, for example, in a situation in which it is necessary to quickly identify positions of victims of a disaster such as earthquakes or tsunamis where buildings may collapse or ground infrastructure (carrier mobile base stations) may be destroyed throughout a specific area and thus the ground infrastructure or GPS cannot be used.

In general, mobile terminals consume a large amount of battery when they conduct positioning. Further, at a timing when victims are affected by a disaster, batteries of the terminals possessed by these victims may not be fully charged. There is also a problem of power consumption of mobile base stations such as drones. It is estimated that the average flight time of general drones that are currently in use is about 30 minutes. It is therefore required to reduce power consumption of the mobile base stations during the movement while maintaining the positioning accuracy within a range where people are able to search (with an error of about 15 m). Ideally, a large number of mobile base stations should be concurrently available. However, if the damage in the affected area is widespread, it may be required to use one mobile base station or a very small number of mobile base stations to perform searching.

In the present disclosure, as described above, positioning may be performed by only one search apparatus 100. Therefore, even in a case in which the number of mobile base stations is limited, searching may be performed efficiently.

Further, in Patent Literature 2, for example, the positioning accuracy is enhanced by a method for checking a response from a mobile terminal many times while gradually moving the mobile base station. Specifically, the mobile base station that sends a response request signal performs searching in the area, and in a case in which there is a response, the mobile base station temporarily moves out of range of radio waves that this mobile base station emits. After that, the mobile base station checks a response to the response request signal while gradually returning to the original radio wave range. The mobile base station thus identifies a mobile terminal. In this method, however, it takes time to identify one mobile terminal. In addition, increases in the moving distance and the moving time of the mobile base station cause the aforementioned problem regarding battery consumption.

On the other hand, according to the present disclosure, it is possible to calculate an approximate position of a mobile terminal by a small amount of searching using radio wave information received at a plurality of places in the search area (whether or not there is a response, a time when radio waves are received, and AoD), and specify the position of the mobile terminal using weak radio waves from the approximate position. Accordingly, compared to the related techniques such as Patent Literature 2, the moving distance of the mobile base station can be reduced. According to the present disclosure, it is possible to rescue victims more efficiently by reducing a time required for searching and reducing an influence on battery consumption.

### Example of Hardware Configuration

Each functional configuration unit of the search apparatus 100 and the aggregation apparatus 200 may be implemented with hardware (e.g., a hardwired electronic circuit) that implements each functional configuration unit or by a combination of hardware with software (e.g., a combination of an electronic circuit with a program that controls the electronic circuit). Hereinafter, a case in which each functional configuration unit of the search apparatus 100 and the like is implemented with a combination of hardware with software will be further described.

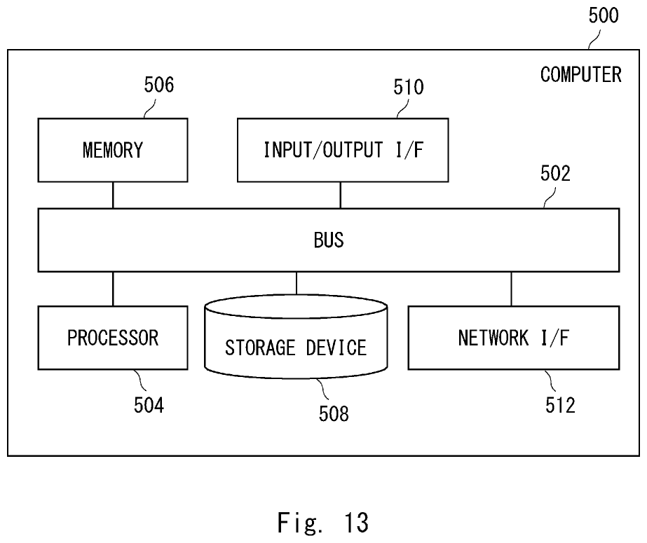

FIG. 13 is a block diagram illustrating a hardware configuration of a computer 500 that implements the search apparatus 100 and the like. The computer 500 may be a portable computer such as a smartphone or a tablet terminal. The computer 500 may be a special-purpose computer that is designed to implement the search apparatus 100 and the like or may be a general-purpose computer.

By installing a predetermined application in the computer 500, for example, each function of the search apparatus 100 and the like is implemented in the computer 500. The above application is formed of a program that implements each functional configuration unit of the search apparatus 100 and the like.

The computer 500 includes a bus 502, a processor 504, a memory 506, a storage device 508, an input/output interface 510, and a network interface 512. The bus 502 is a data transmission path for enabling the processor 504, the memory 506, the storage device 508, the input/output interface 510, and the network interface 512 to transmit and receive data among them. However, the method for connecting the processor 504 and the like to one another is not limited to the bus connection. The processor 504 may be any type of processor such as a Central

Processing Unit (CPU), a Graphics Processing Unit (GPU), or a Field-Programmable Gate Array (FPGA). The memory 506 is a main memory unit that is implemented using a Random Access Memory (RAM) or the like. The storage device 508 is an auxiliary storage device that is implemented by using a hard disk, a Solid State Drive (SSD), a memory card, or a Read Only Memory (ROM).

The input/output interface 510 is an interface for connecting the computer 500 with an input/output device. An input device such as a keyboard and an output device such as a display device are connected, for example, to the input/output interface 510.

The network interface 512 is an interface for connecting the computer 500 to a network. This network may be a Local Area Network (LAN) or a Wide Area Network (WAN).

The storage device 508 stores a program for implementing each functional configuration unit of the search apparatus 100 and the like (a program for implementing the above-mentioned application). The processor 504 loads this program into the memory 506 to execute the loaded program, thereby implementing each functional configuration unit of the search apparatus 100 and the like.

Each of the processors executes one or more programs including instructions for causing a computer to execute an algorithm. This program includes instructions (or software codes) that, when loaded into a computer, cause the computer to perform one or more of the functions described in the embodiments. The program may be stored in various types of non-transitory computer readable media or tangible storage media. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on various types of transitory computer readable media or communication media. By way of example, and not a limitation, transitory computer readable media or communication media can include electrical, optical, acoustical, or other forms of propagated signals.

Note that the present disclosure is not limited to the above-described example embodiments and may be changed as appropriate without departing from the spirit of the present disclosure.

For example, while a drone has been assumed as the search apparatus 100, which is a mobile base station, in the above descriptions, this is merely an example. The search apparatus 100 may be, for example, a vehicle or the like. In this case, although the area in which the search apparatus 100 can move during searching is limited, the influence of a residual amount of battery can be ignored, whereby it is possible for the search apparatus 100 to take more time for searching.

Further, while a case in which the number of mobile base stations that can be actually operated in the event of a large-scale disaster is limited is assumed and the example embodiments in which the smallest number of mobile base stations possible is used have been described in the above description, this is merely an example. In a case in which the number of mobile base stations that are available is not limited, positioning may be performed by using a larger number of mobile base stations so that the positioning accuracy can be enhanced.

In addition, the present disclosure may be applied to fields other than rescue of victims in an event of a large-scale disaster. The present disclosure may be applied, for example, to identification of people in distress in mountain areas. Mountain areas are susceptible to GPS multipath and it is thus thought that mountain areas are one of the areas where GPS accuracy is poor. Further, installation of ground infrastructure is often inadequate for positioning. However, by applying the mobile base station and the method for detecting terminals according to the present disclosure, it becomes possible to immediately rescue people even in mountain areas.

Further, the whole or part of the example embodiments disclosed above can be described as, but not limited to, the following supplementary notes.

### (Supplementary Note 1)

A search apparatus comprising:
a transmission unit configured to transmit, at a plurality of sites, a first communication request signal to a terminal;
a reception unit configured to receive, from the terminal, a first response signal to the first communication request signal; and
a calculation unit configured to calculate an approximate position of the terminal, wherein
the reception unit receives the first response signal including a time of reception of the first communication request signal by the terminal, and
the calculation unit calculates a time difference obtained from a time when the first communication request signal is transmitted and the time when the first communication request signal is received, and calculates an approximate position of the terminal using Observed Time Difference Of Arrival (OTDOA) obtained based on the time difference at at least two of the plurality of sites.

### (Supplementary Note 2)

The search apparatus according to Supplementary Note 1, wherein the calculation unit calculates the approximate position further using Angle of Arrival (AoA) of the first response signal at a site used for the OTDOA.

### (Supplementary Note 3)

The search apparatus according to Supplementary Note 1 or 2, wherein
the reception unit receives the first response signal including Angle of Departure (AoD) of the first communication request signal from a site used for the OTDOA, and
the calculation unit calculates the approximate position by further using the AoD.

### (Supplementary Note 4)

The search apparatus according to Supplementary Note 1, wherein
the reception unit receives the first response signal including AoD of the first communication request signal from a site used for the OTDOA,
the calculation unit calculates a first approximate position using the OTDOA and AoA of the first response signal at a site used for the OTDOA,
the calculation unit calculates a second approximate position using the OTDOA and the AoD, and
the calculation unit calculates a third approximate position using the first and second approximate positions.

### (Supplementary Note 5)

The search apparatus according to any one of Supplementary Notes 1 to 4, wherein
the transmission unit further transmits a second communication request signal to the terminal using radio waves that reach a specific distance from the approximate position,
the reception unit further receives, from the terminal, a second response signal including AoD of the second communication request signal from the approximate position, and
the calculation unit further calculates the position of the terminal based on AoD of the second communication request signal.

### (Supplementary Note 6)

The search apparatus according to Supplementary Note 5, wherein the transmission unit transmits, in a case in which the second response signal is not received, the second communication request signal again by increasing the distance of the radio waves that arrive from the approximate position.

### (Supplementary Note 7)

An aggregation apparatus comprising:
a communication unit configured to receive, from a plurality of search apparatuses that transmit, at a plurality of sites, a first communication request signal to a terminal and receive, from the terminal, a first response signal to the first communication request signal, a time when the first communication request signal is transmitted and a time when the first communication request signal is received by the terminal; and
a calculation unit configured to calculate a time difference obtained from the time of transmission and the time of reception and calculate an approximate position of the terminal using OTDOA obtained based on the time difference at at least two of the plurality of sites.

### (Supplementary Note 8)

The aggregation apparatus according to Supplementary Note 7, wherein
the communication unit further receives AoA of the first response signal at a site used for the OTDOA, and
the calculation unit calculates the approximate position further using the AoA.

### (Supplementary Note 9)

A search system comprising:
a terminal that transmits a first response signal in accordance with a first communication request signal;
a plurality of search apparatuses comprising a transmission unit configured to transmit, at a plurality of sites, a first communication request signal to the terminal and a reception unit configured to receive, from the terminal, the first response signal including a time of reception of the first communication request signal by the terminal; and
an aggregation apparatus comprising a communication unit configured to receive, from the plurality of search apparatuses, a time when the first communication request signal is transmitted and the time when the first communication request signal is received and a calculation unit configured to calculate a time difference obtained from the time of transmission and the time of reception and calculate an approximate position of the terminal using OTDOA obtained based on the time difference at at least two of the plurality of sites.

### (Supplementary Note 10)

The search system according to Supplementary Note 9, wherein
the communication unit further receives AoA of the first response signal at a site used for the OTDOA, and
the calculation unit calculates the approximate position further using the AoA.

### (Supplementary Note 11)

A search method, wherein a computer executes:
a step of transmitting, at a plurality of sites, a first communication request signal to a terminal;
a step of receiving a first response signal to the first communication request signal from the terminal; and
a step of calculating an approximate position of the terminal, wherein
in the receiving step, the first response signal including a time of reception of the first communication request signal by the terminal is received, and
in the calculating step, a time difference obtained from a time when the first communication request signal is transmitted and the time when the first communication request signal is received is calculated and the approximate position of the terminal is calculated using OTDOA obtained based on the time difference at at least two of the plurality of sites.

### (Supplementary Note 12)

A search program for causing a computer to execute:
a step of transmitting, at a plurality of sites, a first communication request signal to a terminal
a step of receiving a first response signal to the first communication request signal from the terminal; and
a step of calculating an approximate position of the terminal, wherein
in the receiving step, the first response signal including a time of reception of the first communication request signal by the terminal is received, and
in the calculating step, a time difference obtained from a time when the first communication request signal is transmitted and the time when the first communication request signal is received is calculated and the approximate position of the terminal is calculated using OTDOA obtained based on the time difference at at least two of the plurality of sites.

While the present invention has been described above with reference to the example embodiments, the present invention is not limited to the example embodiments. Various changes that can be understood by those skilled in the art within the scope of the present invention can be made to the configurations and the details of the present invention.

This application is based upon and claims the benefit of priority from Japanese Patent Application No. 2020-205674, filed on Dec. 11, 2020, the disclosure of which is incorporated herein in its entirety by reference.

### REFERENCE SIGNS LIST

10 Search Apparatus
11 Transmission Unit
12 Reception Unit
13 Calculation Unit
100, 100a, 100b Search Apparatus
110 Moving Apparatus
120 Antenna
130 Movement Control Unit
140 Request Control Unit
150 Time Synchronization Unit
160 Base Station Unit
161 Transmission Unit
162 Reception Unit
170 Calculation Unit
180 Storage Unit
190 Communication Unit
200 Aggregation Apparatus
270 Calculation Unit
280 Storage Unit
290 Communication Unit
300 Mobile Terminal
400 Searcher's Terminal
500 Computer
502 Bus
504 Processor
506 Memory
508 Storage Device
510 Input/output Interface
512 Network Interface
900a-900c Base Station
1000 Search System

What is claimed is:

1. A search apparatus comprising:
at least one memory storing instructions, and
at least one processor configured to execute the instructions to:
transmit, at a plurality of sites, a first communication request signal to a terminal;
receive, from the terminal, a first response signal to the first communication request signal; and
calculate an approximate position of the terminal, wherein
the at least one processor is configured to execute the instructions to
receive the first response signal including a time of reception of the first communication request signal by the terminal, and
calculate a time difference obtained from a time when the first communication request signal is transmitted and the time when the first communication request signal is received, and calculate an approximate position of the terminal using Observed Time Difference Of Arrival (OTDOA) obtained based on the time difference at at least two of the plurality of sites.

2. The search apparatus according to claim 1, wherein the at least one processor is further configured to execute the instructions to calculate the approximate position further using Angle of Arrival (AoA) of the first response signal at a site used for the OTDOA.

3. The search apparatus according to claim 1, wherein the at least one processor is further configured to execute the instructions to
receive the first response signal including Angle of Departure (AoD) of the first communication request signal from a site used for the OTDOA, and
calculate the approximate position by further using the AoD.

4. The search apparatus according to claim 1, wherein the at least one processor is further configured to execute the instructions to
receive the first response signal including AoD of the first communication request signal from a site used for the OTDOA,
calculate a first approximate position using the OTDOA and AoA of the first response signal at a site used for the OTDOA,
calculate a second approximate position using the OTDOA and the AoD, and
calculate a third approximate position using the first and second approximate positions.

5. The search apparatus according to claim 1, wherein the at least one processor is further configured to execute the instructions to
further transmit a second communication request signal to the terminal using radio waves that reach a specific distance from the approximate position,
further receive, from the terminal, a second response signal including AoD of the second communication request signal from the approximate position, and
further calculate the position of the terminal based on AoD of the second communication request signal.

6. The search apparatus according to claim 5, wherein the at least one processor is further configured to execute the instructions to transmit, in a case in which the second response signal is not received, the second communication request signal again by increasing the distance of the radio waves that arrive from the approximate position.

7. An aggregation apparatus comprising:
at least one memory storing instructions, and
at least one processor configured to execute the instructions to:
receive, from a plurality of search apparatuses that transmit, at a plurality of sites, a first communication request signal to a terminal, and receive, from the terminal, a first response signal to the first communication request signal, a time when the first communication request signal is transmitted and a time when the first communication request signal is received by the terminal; and
calculate a time difference obtained from the time of transmission and the time of reception and calculate an approximate position of the terminal using OTDOA obtained based on the time difference at at least two of the plurality of sites.

8. The aggregation apparatus according to claim 7, wherein the at least one processor is further configured to execute the instructions to
further receive AoA of the first response signal at a site used for the OTDOA, and
calculate the approximate position further using the AoA.

9-10. (canceled)

11. A search method, wherein a computer executes the following processing of:
transmitting, at a plurality of sites, a first communication request signal to a terminal;
receiving, from the terminal, a first response signal to the first communication request signal; and
calculating an approximate position of the terminal, wherein
in the receiving of the first response signal, the first response signal including a time of reception of the first communication request signal by the terminal is received, and
in the calculating of the approximate position of the terminal, a time difference obtained from a time when the first communication request signal is transmitted and the time when the first communication request signal is received is calculated and the approximate position of the terminal is calculated using OTDOA obtained based on the time difference at at least two of the plurality of sites.

12. (canceled)
